(19) United States
(12) Patent Application Publication
(10) Pub. No.: US 2026/0284852 A1
(43) Pub. Date: Sep. 24, 2026

(54) DRIVING TOOL

(71) Applicant: MAKITA CORPORATION, Anjo-shi (JP)

(72) Inventors: Isao MIYASHITA, Anjo-shi (JP); Kiyonobu YOSHIKANE, Anjo-shi (JP); Hiromu SAKUMA, Anjo-shi (JP)

(73) Assignee: MAKITA CORPORATION, Anjo-shi, Aichi (JP)

(21) Appl. No.: 19/567,720

(22) Filed: Mar. 16, 2026

(30) Foreign Application Priority Data
Mar. 18, 2025 (JP) 2025-043357
Dec. 8, 2025 (JP) 2025-239378

(51) Int. Cl. B25C 5/16; B25C 5/15; F16B 15/00; F16B 15/08

(52) U.S. Cl. CPC B25C 5/1665; F16B 15/0015; F16B 15/08; B25C 5/15

(57) ABSTRACT

A driving tool includes a drive channel through which staples are supplied. A driver is configured to strike a staple in the drive channel. The struck staple contacts a movable member at a protruding position where the movable member protrudes into the drive channel. The movable member contacted by the staple moves to a retracted position retracted from the drive channel in a direction away from a feed-side of the staples.

### CROSS-REFERENCE TO RELATED APPLICATIONS

This application claims priority to Japanese patent application serial number 2025-043357 filed Mar. 18, 2025, and Japanese patent application serial number 2025-239378 filed Dec. 8, 2025 the contents of which are incorporated herein by reference in their entirety for all purposes.

### BACKGROUND

### Field of the Disclosure

The present disclosure relates to a driving tool.

### Description of Related Art

Staples are typically U-shaped and are used to attach mounting members to workpieces. For example, staples for electric wire used for attaching electric wires to, for example, wooden posts are known. This type of staple is provided with a resin covering body made of resin to prevent damage to the electric wires. Specifically, the staple has a U-shaped body made of metal and a covering body that covers a crown of the U-shaped body. A plurality of staples are arranged side by side and connected via ribs that connect the covering bodies.

The connected staples are accommodated in a magazine of a driving tool. The staples are fed one by one from the magazine to a drive channel of the tool body. Within the drive channel, the staples are struck by a driver. The driver drives the staples while breaking the ribs of the covering body. Consequently, the rib acts as a resistance, causing the staple to tilt. Specifically, the staples tilt about the ribs provided on one side of the rear side, with the front end of the staples tilting toward the rib side, and pass through the drive channel in that posture.

Conventional driving tool has a protrusion that extends into the drive channel. This protrusion contacts a leading end of the covering body of the staple moving within the drive channel. This corrects the orientation of the staple. A weakened portion that breaks upon collision with the protrusion is formed at the point of the covering body that contacts the protrusion. By breaking the weakened portion, the staple passes through the protrusion and is properly driven. However, this configuration requires providing a weakened portion in the covering body, which complicates the staple structure and makes manufacturing difficult.

Accordingly, there is a need for a driving tool that can correct the orientation of staples with a simpler configuration.

### SUMMARY

In one aspect of the present disclosure, a driving tool has a drive channel through which staples are fed. A driver strikes the staple in the drive channel. The struck staple contacts a movable member at a protruding position where the movable member protrudes into the drive channel. The movable member contacted by the staple moves to a retracted position where the movable member retracts from the drive channel in a direction away from a feed-side of the staples. Accordingly, by the staple contacting the movable member, an orientation of the staple can be changed to a more preferable direction. Also, the movable member moves to the retracted position while being in contact with the staple. This prevents the movable member from obstructing the driving of the staple, thereby ensuring that the staple is properly driven.

### BRIEF DESCRIPTION OF THE DRAWINGS

FIG. 1 is a right side view of a driving tool according to the present disclosure with a portion of the housing removed.

FIG. 2 is a longitudinal sectional view of a driving nose.

FIG. 3 is a perspective view of the drive channel as viewed from above.

FIG. 4 is a perspective view of the drive channel as viewed from below.

FIG. 5 is a cross-sectional view corresponding to FIG. 2, showing a state where a driver has struck the staple.

FIG. 6 is a cross-sectional view corresponding to FIG. 2, showing a state where the staple contacts a movable member.

FIG. 7 is a cross-sectional view corresponding to FIG. 2, showing a state where the movable member has moved to a retracted position.

FIG. 8 is a cross-sectional view corresponding to FIG. 2, showing a state where the staple is driven out.

FIG. 9 is a vertical sectional view of a driving nose according to a second embodiment.

FIG. 10 is a plan view of a contact arm.

FIG. 11 is a perspective view of a connected staples.

FIG. 12 is a plan view of a single staple.

FIG. 13 is a view taken along a line XIII in FIG. 12, and is a side view of the single staple.

### DETAILED DESCRIPTION

In according to another aspect of the present disclosure, a biasing member biases a movable member toward the protruding position. Accordingly, the movable member contacts the staple with an appropriate amount of force. The movable member then retracts with an appropriate amount of force.

In another aspect of the present disclosure, a rolling element is provided between the biasing member and the movable member. The rolling element reduces friction between the biasing member and the movable member. As a result, the movable member moves more easily relative to the biasing member.

In another aspect of the present disclosure, a groove for receiving the rolling element is formed in the movable member. The rolling element is received within the groove. As a result, the rolling element can roll properly between the movable member and the biasing member without falling out.

In another aspect of the present disclosure, the groove has a shape that deepens toward a striking direction of the driver. Consequently, as the rolling element approaches a side opposite to the striking direction, the rolling element projects further from the groove toward the biasing member. As a result, a spacing between the movable member in the retracted position and the biasing member is increased to avoid mutual interference. Additionally, an initial position of the rolling element can be set on a side in the striking direction within the groove. Accordingly, it is possible to allow a relative displacement of the rolling element in the direction opposite to the striking direction with respect to the movable member, which is caused by a difference in movement amount between the movable member advancing in the striking direction and the rolling element.

In another aspect of the present disclosure, the biasing member is a leaf spring. Thus, the movable member can be biased with the simple structure of a leaf spring.

In another aspect of the present disclosure, a base portion of the leaf spring in the striking direction of the driver is supported by the tool body. A front portion of the leaf spring in the striking direction pushes the movable member. Therefore, the leaf spring pushes the movable member at the front portion in the striking direction. The base portion of the leaf spring is supported at a relatively wide location on the center side of the tool body. Thus, the flexibility for the installation location of the leaf spring is high.

In another aspect of the present disclosure, the driving tool has an advance and retract path for the movable member. A front wall of the advance and retract path in the striking direction has a guide slope extending in the staple feed direction toward the striking direction of the driver. When the movable member is pushed in the striking direction by the staple, the movable member is guided along the guide slope and moves in a direction away from the feed-side.

In another aspect of the present disclosure, the movable member has a slide ramp surface that engages with the guide slope at a front end in the striking direction and slides along the guide slope. This allows the movable member to slide easily along the guide slope and move to the retracted position in a stable posture.

In another aspect of the present disclosure, the driver is formed with a receiving groove that extends in the striking direction and allows the movable member to move. Consequently, the movable member does not interfere with the driver when a staple is driven.

In another aspect of the present disclosure, a plurality of staples arranged side by side are connected via a connecting portion with gaps between legs adjacent to each other in the feed direction. The plurality of staples are fed one by one into a drive channel. Even in a configuration where a struck staple is tilted in a direction opposite to the feed direction by the connecting portion, the movable member can appropriately correct the orientation of the staple.

In another aspect of the present disclosure, the staple has a U-shaped body made of metal and a covering body made of resin configured to cover at least a portion of a crown of the U-shaped body. The covering body prevents damage to a member to be struck, such as an electric wire.

In another aspect of the present disclosure, compression springs are provided for biasing the driver in the striking direction. The driver can strike the staple by the spring force of the compression spring.

In another aspect of the present disclosure, a driving tool has a contact arm. The contact arm is movably provided on a driver guide having a drive channel and is brought into contact with a workpiece or a fixing object. The contact arm is disposed to overlap at least a part of an interference mechanism in a thickness direction of the contact arm. The interference mechanism includes a movable member, a biasing member, and a rolling element. Thus, the interference mechanism is compactly disposed in the thickness direction of the contact arm (i.e., a direction intersecting an extending direction). This makes it possible to reduce a so-called center height of a driving nose.

In another aspect of the present disclosure, the contact arm has a hollow portion in which at least a part of the interference mechanism is inserted. Therefore, the interference mechanism and the contact arm are disposed overlapping in the thickness direction by a simple configuration.

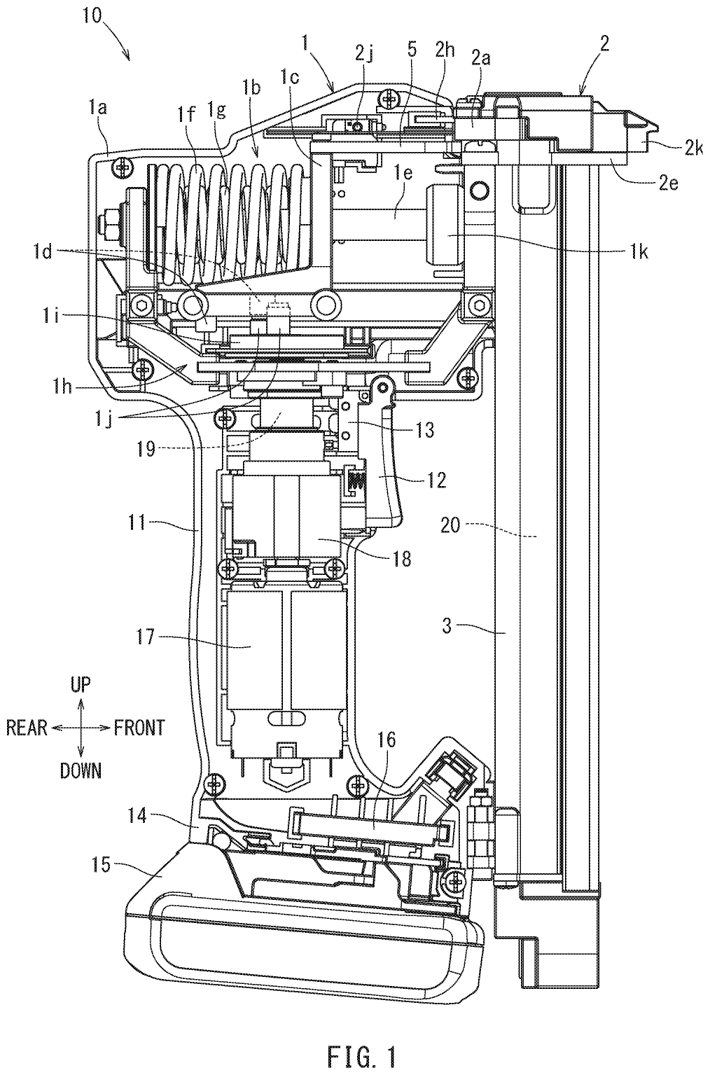

Next, one embodiment of the present disclosure will be described with reference to FIGS. 1 to 8. As shown in FIG. 1, a driving tool 10 is of a mechanical spring type that drives staples 20 using, for example, spring force of a compression spring. In the following description, a driving direction of the staple 20 (a striking direction of the driver 5) is defined as a front direction, and a counter-driving direction is defined as a rear direction. A user grips the driving tool 10 by hand and is positioned at the rear of the driving tool 10 (left side of the sheet in FIG. 1). Up-down and left-right directions are defined with reference to the user.

As shown in FIG. 1, the driving tool 10 has a tool body 1 at its upper portion. The tool body 1 has a substantially cylindrical housing 1a extending in the front-rear direction. The housing 1a accommodates a driving mechanism 1b. The driving mechanism 1b has a shaft 1e extending front and rear. A plunger 1c is attached to the shaft 1e to be reciprocally movable in the front-rear direction. Behind the plunger 1c, an outer spring 1f and an inner spring 1g, which are compression springs, are provided. The spring force of the outer spring 1f and the inner spring 1g acts as thrust for moving the plunger 1c forward.

As shown in FIG. 1, a cylindrical grip 11 extending up and down is provided at a lower portion of the tool body 1. A trigger 12 is provided on an upper front surface of the grip 11. A user grasps the grip 11 and pulls the trigger 12 to operate it with his/her fingertip. A trigger switch 13 is provided behind the trigger 12, which switches from an OFF state to an ON state by a pulling operation of the trigger 12. This pulling operation of the trigger 12 is effective only when a switch 2j is in an ON state due to retraction of a contact arm 2h.

A battery mounting portion 14 extending in the front-rear direction is provided below the grip 11. A battery pack 15 is removably mounted to the battery mounting portion 14. The battery pack 15 can be attached to and removed from the battery mounting portion 14 by sliding movement along the front-rear direction. The battery pack 15 operates as a power source that supplies electric power to a motor 17 and other components described later. A controller 16 is disposed above the battery pack 15. The controller 16 primarily controls driving of the motor 17.

The motor 17 serving as a drive source is housed in a lower interior of the grip 11. The motor 17 is held in a posture with its axis oriented in the up-down direction. The motor 17 is activated by a pulling operation of the trigger 12 using electric power from the battery pack 15 as a power source. A reduction gear train 18 is provided above the motor 17. The reduction gear train 18 has an output shaft 19 protruding upward. A winding mechanism 1h is provided above the output shaft 19. The motor 17, the output shaft 19, and the winding mechanism 1h are coaxially aligned. A rotational output of the motor 17 is decelerated by the reduction gear train 18 and output to the winding mechanism 1h.

As shown in FIG. 1, the winding mechanism 1h is located below the driving mechanism 1b and is housed inside the housing 1a. The winding mechanism 1h has a wheel 1i connected to the output shaft 19. The wheel 1i rotates integrally with the output shaft 19. Two engaging portions 1j projecting upward are provided on an upper surface of the wheel 1i. Each engaging portion 1j is a cylindrical shaft member extending in the up-down direction.

The motor 17 starts when the user pulls the trigger 12 with the above-described switch 2j in the ON state. When the wheel 1i rotates, the engaging portions 1j of the winding mechanism 1h engage with the engaged portions 1d of the plunger 1c from the front and push the plunger 1c rearward. This causes the plunger 1c to move to the top dead center immediately before driving. When the wheel 1i continues to rotate further, the engagement of the engaging portions 1j with the engaged portions 1d is released. As a result, the plunger 1c advances due to the spring force of the outer spring 1f and the inner spring 1g. The advanced plunger 1c collides with the damper 1k. The damper 1k stops the advancement of the plunger 1c and absorbs the impact at the time of collision. The damper 1k prevents damage to the plunger 1c.

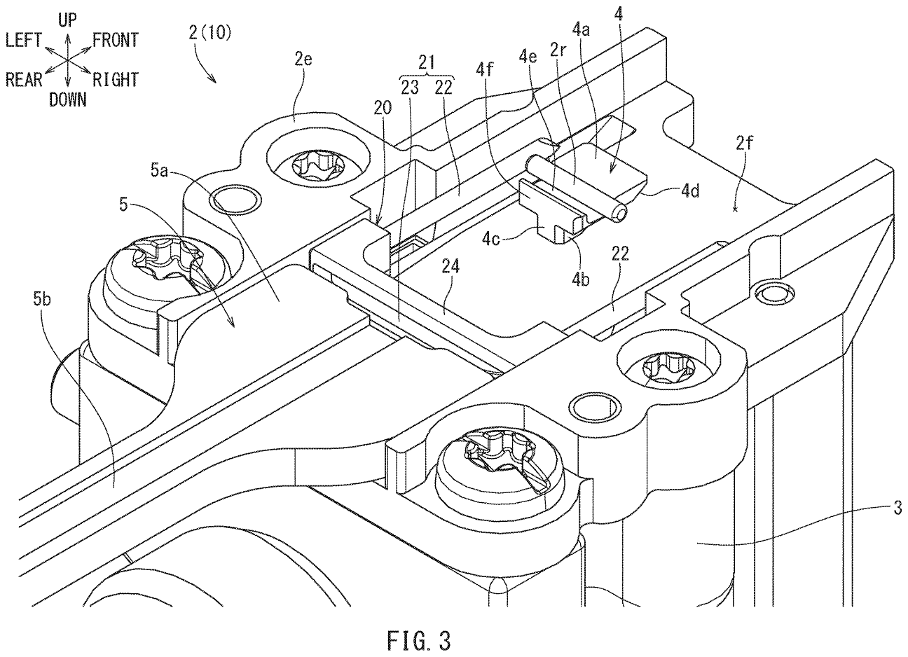

As shown in FIG. 1, a flat plate-shaped driver 5 that is elongated in the front-rear direction is attached to a front upper end of the plunger 1c. The driver 5 moves in the front-rear direction integrally with the plunger 1c. An end portion 5a of the driver 5 enters into the driving nose 2. As shown in FIG. 3, the end portion 5a of the driver 5 has a wide shape in the left-right direction to match the width of the staple 20. A concave receiving groove 5b extending along the front-rear direction is formed in the center of the upper surface of the driver 5. The receiving groove 5b prevents interference between the driver 5 and the movable member 4 described later when the driver 5 advances.

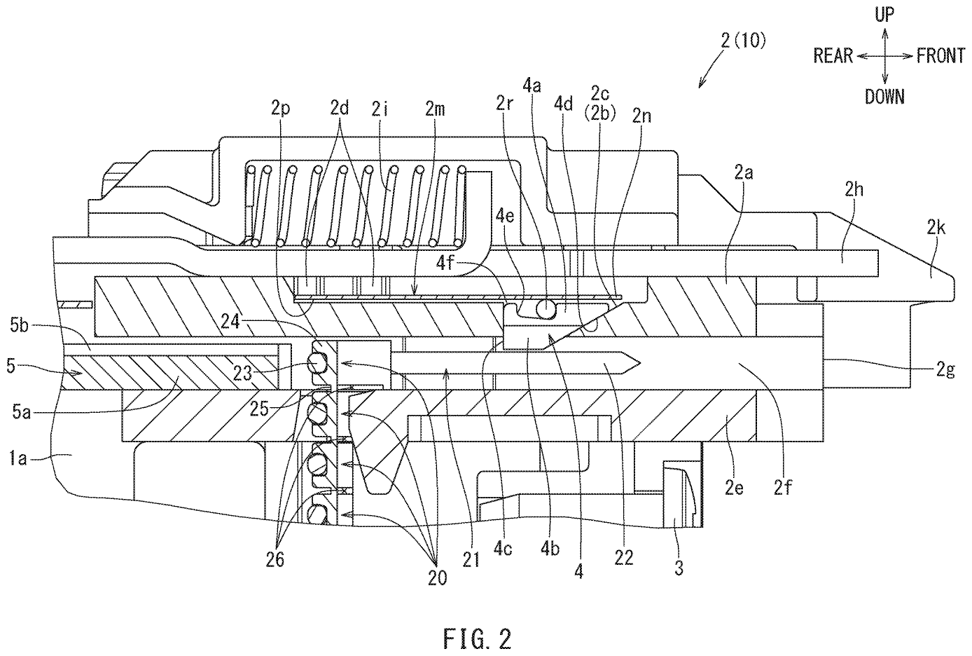

As shown in FIG. 1, the driving nose 2 is provided at a front of the tool body 1. The driving nose 2 has an upper driver guide 2a and a lower driver guide 2e that are connected to each other in the up-down direction. As shown in FIG. 2, a drive channel 2f is formed between the upper driver guide 2a and the lower driver guide 2e. A rear end of the drive channel 2f communicates with an interior of the housing 1a. The front end of the drive channel 2f forms an ejection port 2g from which staples 20 are driven out. A substantially rectangular box-shaped magazine 3 extending up and down is connected to a lower surface of the lower driver guide 2e. A plurality of staples 20 arranged in parallel in the up-down direction are accommodated within the magazine 3. The staples 20 are fed one by one upward from within the magazine 3 toward the drive channel 2f.

As shown in FIGS. 2 and 3, the staple 20 is a staple for securing electric wire for fastening electric wires to a workpiece, such as a post. The staple 20 has a U-shaped body 21 formed by bending a wire material made of metal. The U-shaped body 21 has a pair of legs 22 and a crown 23 connecting the respective legs 22. Furthermore, the staple 20 has a covering body 24 made of resin that covers the crown 23 from the periphery. The covering body 24 opens rearward so as to expose a rear surface of the crown 23 (contact surface with the driver 5) to the rear. The covering body 24 protects the electric wire to be fastened and enhances insulation properties of the staple 20. Each covering body 24 is connected to adjacent ones in the up-down direction via rib-shaped connecting portions 25. The respective staples 20 are thereby connected so as to leave gaps 26 in the up-down direction.

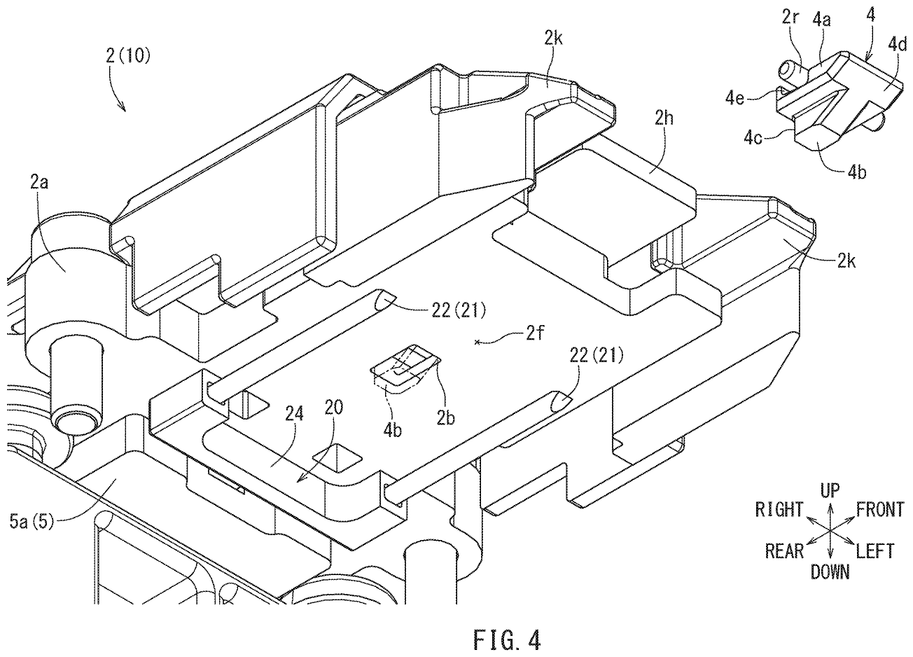

As shown in FIGS. 2 and 4, the driving nose 2 has a contact arm 2h extending in the front-rear direction. The contact arm 2h is slidable in the front-rear direction relative to the upper driver guide 2a. The contact arm 2h is biased by a spring 2i to advance forward relative to the upper driver guide 2a. The contact arm 2h retracts along the upper driver guide 2a when pressed against a workpiece or electric wire. By retracting, the contact arm 2h presses a rear switch 2j (see FIG. 1) to switch it to an ON state.

As also shown in FIG. 2, the driving nose 2 has cable guides 2k on both left and right sides of the contact arm 2h. Each cable guide 2k can slide independently in the front-rear direction relative to the upper driver guide 2a. Each cable guide 2k is biased forward. A front end of each cable guide 2k is positioned forward of a front end of the contact arm 2h. By ejecting a staple 20 with an electric wire passed between the cable guides 2k, the electric wire can be properly positioned between the legs 22 of the staple 20.

As shown in FIG. 2, the upper driver guide 2a is formed with an advance and retract path 2b penetrating in the up-down direction. A front wall of the advance and retract path 2b forms a guide slope 2c extending obliquely upward toward the front. The guide slope 2c is inclined upward about 15 to 40 degrees with respect to the front-rear direction. A movable member 4 is provided in the advance and retract path 2b so as to be movable relative to the upper driver guide 2a.

The upper driver guide 2a is also provided with a leaf spring 2m extending in the front-rear direction. The leaf spring 2m has its rear portion 2p supported in a cantilever manner by a support portion 2d of the upper driver guide 2a. The support portion 2d is provided at four locations by forming two projections spaced apart in the front-rear direction, each forming a left-right pair. The support portion 2d may alternatively be provided as a single long projection extending in the front-rear direction and arranged as a left-right pair. By supporting the rear portion 2p of the leaf spring 2m in a cantilever manner, the front portion 2n can move up and down relative to the upper driver guide 2a. The rear portion 2p is brought in contact from above to a rolling element 2r described later. The leaf spring 2m biases the movable member 4 downward via the rolling element 2r. Thereby, the movable member 4 protrudes from the advance and retract path 2b into the drive channel 2f in the initial state (protruding position).

Furthermore, the support portion 2d may be configured to allow adjustment of the biasing force applied by the leaf spring 2m. For example, an adjustment screw (not shown) may be threaded into the upper driver guide 2a above the rear portion 2p of the leaf spring 2m. By tightening or loosening this adjustment screw, the vertical position of the rear portion 2p or a fulcrum point of the leaf spring 2m can be displaced. This displacement changes the initial deflection amount of the leaf spring 2m, thereby increasing or decreasing the downward biasing force acting on the movable member 4 via the rolling element 2r. This configuration allows the user to optimize the resistance of the movable member 4 based on the wire gauge or the hardness of the covering body 24 of the staples 20 being used, ensuring consistent orientation correction without causing jamming.

As shown in FIGS. 3 and 4, the movable member 4 is a substantially rectangular parallelepiped metal member. The movable member 4 has an upper region 4a extending in a generally planar manner, and a protruding portion 4b protruding downward from the left-right center of the upper region 4a. This protruding portion 4b protrudes from an opening of the advance and retract path 2b into the drive channel 2f in the initial state. As shown in FIG. 2, the protruding portion 4b protrudes so as to be positioned only on the upper side from the up-down center of the drive channel 2f. Specifically, the protruding portion 4b is positioned such that it does not overlap with the legs 22 of the staple 20 in the up-down direction when viewed from the side. In the protruding position, the upper region 4a catches on the peripheral wall of the opening from above. Thereby, the movable member 4 can be prevented from completely falling out from the upper driver guide 2a into the drive channel 2f.

As shown in FIG. 2, a rear surface 4c of the movable member 4 forms a surface orthogonal to the front-rear direction. A front surface of the movable member 4 forms a slide ramp surface 4d extending obliquely upward toward the front. The slide ramp surface 4d is formed across the protruding portion 4b and the upper region 4a. An inclination angle of the slide ramp surface 4d corresponds to an angle of the guide slope 2c of the advance and retract path 2b. The slide ramp surface 4d is surface aligned with the guide slope 2c. This allows the movable member 4 to slide easily along the guide slope 2c.

As shown in FIGS. 2 and 3, a groove 4e extending along the left-right direction is formed on the upper surface of the movable member 4. The groove 4e is formed across the entire region in the left-right direction of the upper region 4a. The groove 4e has an inclined shape that gradually deepens toward the front. A cylindrical rolling element 2r with its axis oriented in the left-right direction is provided in the groove 4e so as to be movable in the front-rear direction. The rolling element 2r is positioned at the front area of the groove 4e in the initial position due to the inclined shape of the groove 4e. The rolling element 2r extends longer than the left-right width of the upper region 4a. The diameter of the rolling element 2r is greater than the maximum depth of the groove 4e. Therefore, the rolling element 2r projects above the upper surface of the movable member 4 at any position in the front-rear direction. The rolling element 2r rolls between the movable member 4 and the leaf spring 2m when the movable member 4 slides along the guide slope 2c. Thereby, the rolling element 2r reduces friction between the movable member 4 and the leaf spring 2m. As a result, the movable member 4 can move smoothly relative to the leaf spring 2m. In particular, when the leaf spring 2m biases the movable member 4 downward, the movable member 4 can be appropriately lowered.

While the rolling element 2r is described as a preferred embodiment for reducing friction between the movable member 4 and the biasing member 2m, the present disclosure is not limited to this configuration. Alternatively, a low-friction sliding layer (not shown), such as a polytetrafluoroethylene (PTFE) coating, a diamond-like carbon (DLC) coating, or a separate sliding plate made of self-lubricating resin, may be provided on the upper surface of the movable member 4 or the contact surface of the leaf spring 2m. In such configurations, the groove 4e may be omitted, and the leaf spring 2m may slide directly against the low-friction surface of the movable member 4. This ensures smooth retraction of the movable member 4 even without a rolling element.

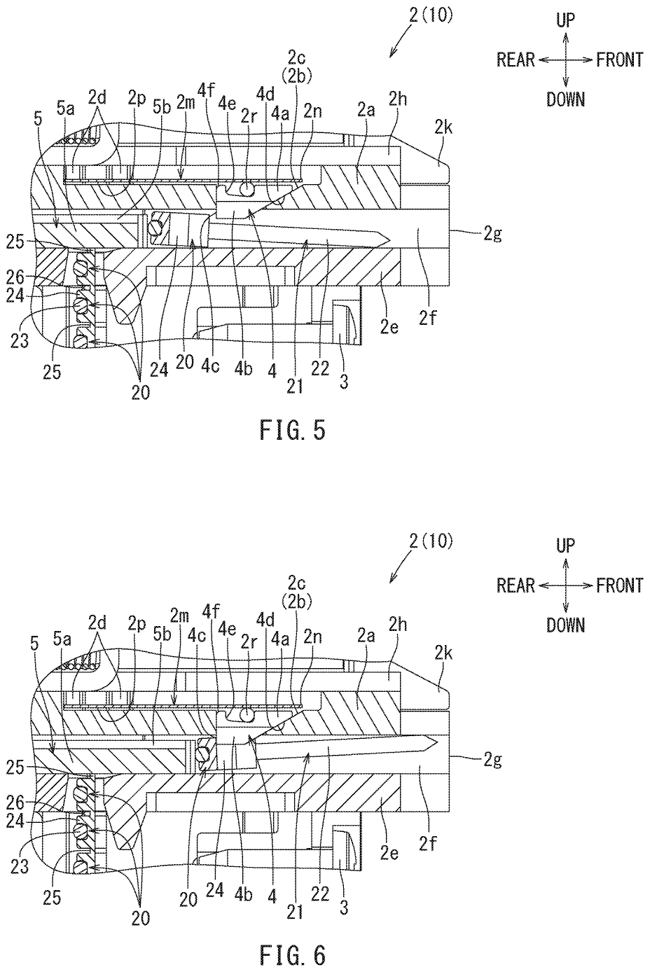

Hereinafter, a series of the driving operations by forward movement of the driver 5 will be described. FIG. 2 shows a state in which the driver 5 is positioned between the standby position and the top dead center. As shown in FIG. 5, when the driver 5 advances forward, a tip portion 5a of the driver 5 strikes the staple 20 in the drive channel 2f. This strike causes the driver 5 to break the connecting portion 25 that connects the staple 20 in the drive channel 2f and the next staple 20. At this time, the connecting portion 25 acts as resistance, causing the staple 20 to tilt about the connecting portion 25. That is, the staple 20 advances forward in a tilted posture with its tip oriented obliquely downward.

As shown in FIG. 6, as the staple 20 advances further forward, an upper front side of the covering body 24 collides from behind with a rear surface 4c of the protrusion 4b of the movable member 4. As a result, the movable member 4 acts as a resistance, causing the staple 20 to tilt about the movable member 4. That is, the staple 20 is switched to a tilted posture with its tip oriented obliquely upward.

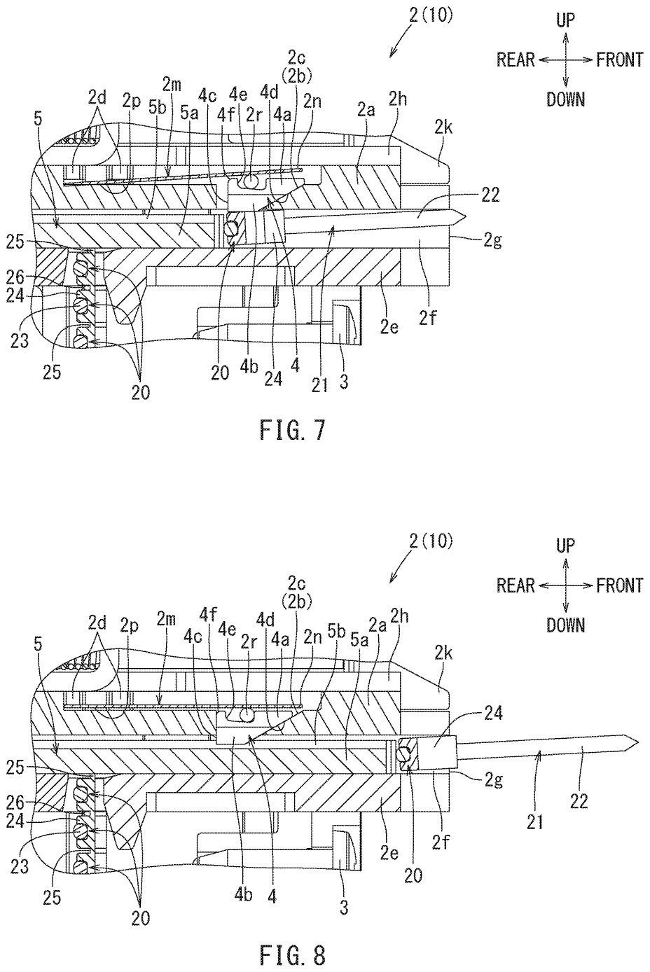

As shown in FIG. 7, the staple 20 is pushed by the driver 5 and advances further forward. Thereby, the movable member 4 is pressed forward. As a result, the movable member 4 slides along the guide slope 2c of the advance and retract path 2b to advance while rising. Thereby, the protrusion 4b of the movable member 4 is pushed up to a retracted position where it retracts from above the drive channel 2f. By the retraction of the protrusion 4b, obstacles that impede the forward movement of the staple 20 are eliminated, allowing the staple 20 to advance properly.

As shown in FIG. 7, the movable member 4 rises against the spring force of the leaf spring 2m. Also, the rolling element 2r rolls as the movable member 4 advances. Therefore, the movable member 4 can move smoothly relative to the leaf spring 2m. The rolling element 2r retreats relative to the movable member 4. Thereby, the rolling element 2r moves to the rear where the depth of the groove 4e is shallow and pushes the leaf spring 2m further upward. Therefore, the rolling element 2r can avoid interference between the upper end portion 4f of the rear surface 4c of the movable member 4 and the leaf spring 2m. Also, the upper end portion 4f is formed into a rounded shape by R-processing. Accordingly, interference between the upper end portion 4f and the leaf spring 2m can be prevented more reliably.

As shown in FIG. 8, the staple 20 passes through the movable member 4. This causes the movable member 4 to be biased downward by the spring force of the leaf spring 2m. The movable member 4 descends along the guide slope 2c, and the protrusion 4b protrudes into the drive channel 2f. The protruding protrusion 4b is received in the receiving groove 5b of the driver 5. Accordingly, interference of the movable member 4 with the driver 5 is avoided.

Also, the staple 20 that has passed through the movable member 4 is driven out from the ejection port 2g with its tip oriented obliquely upward. This makes it possible to appropriately drive the staple 20 into the workpiece. More specifically, generally, the tool body 1 of the driving tool 10 receives reaction force due to the driving operation. As shown in FIG. 1, the center of gravity of the driving tool 10 is then positioned lower than the tool body 1 due to the motor 17 and the battery pack 15. Therefore, the driving tool 10 may rotate counterclockwise around the grip 11 held by the user due to reaction force when viewed in the orientation of FIG. 1. In that case, the driver 5 assumes a posture orienting diagonally upward.

If the staple 20 were to advance in a posture facing obliquely downward without providing the movable member 4, the staple 20 would be driven out while tilted in a direction away from the driver 5. This could result in the driver 5 becoming disengaged from the staple 20 and failing to drive it properly. On the other hand, in the present disclosure, the movable member 4 switches the posture of the staple 20 to face obliquely upward. Therefore, even if the driver 5 faces obliquely upward due to recoil during driving, the staple 20 is tilted in the same direction as the driver 5. Thereby, the staple 20 can be properly driven into the workpiece by the driver 5.

Moreover, as shown in FIGS. 2 and 6, the movable member 4 is disposed forward of the center in the front-rear direction of the upper driver guide 2a. Specifically, the movable member 4 is disposed so as to switch the posture of the staple 20 immediately before the tip of the staple 20 is ejected from the ejection port 2g (see FIG. 6). Therefore, the staple 20 can be easily ejected from the ejection port 2g immediately after switching to the posture oriented obliquely upward. Note that the movable member 4 does not necessarily change the orientation of the staple 20 to the obliquely upward direction, and may, for example, change the orientation of the staple 20 to be horizontal with respect to a striking direction.

As described above, as shown in FIG. 2, a driving tool 10 has a drive channel 2f through which staples 20 are fed. A driver 5 strikes the staple 20 in the drive channel 2f. The struck staple 20 contacts a movable member 4 at a protruding position where the movable member 4 protrudes into the drive channel 2f. The movable member 4 in contact with the staple 20 moves to a retracted position where the movable member 4 retracts from the drive channel 2f in a direction away from the feed-side of the staples 20. Therefore, by the staple 20 contacting the movable member 4, the orientation of the staple 20 can be changed to a more preferable direction. Also, the movable member 4 moves to the retracted position while being in contact with the staple 20. This allows the movable member 4 to not obstruct the driving of the staple 20, thereby ensuring the staple 20 to be properly driven.

As shown in FIG. 2, a biasing member biases a movable member 4 toward the protruding position. Therefore, the movable member 4 contacts the staple 20 with an appropriate force. The movable member 4 then retracts with an appropriate force.

As shown in FIG. 2, a rolling element 2r is provided between a biasing member and the movable member 4. Therefore, the rolling element 2r reduces friction between the biasing member and the movable member 4. As a result, the movable member 4 moves more easily relative to the biasing member.

As shown in FIG. 2, a groove 4e for receiving the rolling element 2r is formed in the movable member 4. Therefore, the rolling element 2r enters the groove 4e. As a result, the rolling element 2r can roll properly between the movable member 4 and the biasing member without falling out.

As shown in FIG. 2, the groove 4e has a shape that deepens toward the striking direction of the driver 5. Therefore, as the rolling element 2r approaches the side opposite to the striking direction, it projects more greatly from the groove 4e toward the biasing member. As a result, the spacing between the movable member 4 in the retracted position and the biasing member is increased to avoid mutual interference. Additionally, the initial position of the rolling element 2r can be positioned on the side at the end in the striking direction within the groove 4e. Accordingly, it is possible to allow a relative displacement of the rolling element 2r in a direction opposite to the striking direction with respect to the movable member 4, which is caused by a difference in movement amount between the movable member 4 advancing in the striking direction and the rolling element 2r.

As shown in FIG. 2, the biasing member is a leaf spring 2m. Therefore, the movable member 4 can be biased with a simple structure of the leaf spring 2m.

As shown in FIG. 2, a base portion of the leaf spring 2m in the striking direction of the driver 5 is supported by the tool body 1. A front portion of the leaf spring 2m in the striking direction pushes the movable member 4. Therefore, the leaf spring 2m pushes the movable member 4 at the front portion in the striking direction. The base portion of the leaf spring 2m is supported at a relatively wide location on the center side of the tool body 1. Thus, the flexibility for the installation location of the leaf spring 2m is high.

As shown in FIG. 2, the driving tool 10 has an advance and retract path 2b for the movable member 4. A front wall of the advance and retract path 2b in the striking direction has a guide slope 2c extending in the staple 20 feed direction (upward) toward the striking direction of the driver 5. Therefore, when the movable member 4 is pushed in the striking direction by the staple 20, the movable member 4 is guided along the guide slope 2c and moves in a direction away from the feed-side.

As shown in FIG. 2, the movable member 4 has a slide ramp surface 4d that engages with the guide slope 2c at a front end in the striking direction and slides along the guide slope 2c. Therefore, the movable member 4 can easily slide along the guide slope 2c. This allows the movable member 4 to move to the retracted position in a stable posture.

As shown in FIGS. 2 and 3, the driver 5 is formed with a receiving groove 5b that extends in the striking direction and allows movement of the movable member 4. Therefore, the movable member 4 does not interfere with the driver 5 when a staple 20 is driven.

As shown in FIG. 2, a plurality of staples 20 arranged side by side are connected via a connecting portion 25 with gaps 26 between legs 22 adjacent to each other in the feed direction. The plurality of staples 20 are fed one by one into a drive channel 2f. Therefore, even in a configuration where a tip end of the struck staple 20 is tilted in a direction opposite to the feed direction (downward) by the connecting portion 25, the movable member 4 can appropriately correct the orientation of the staple 20.

As shown in FIGS. 2 and 3, the staple 20 has a U-shaped body 21 made of metal and a covering body 24 made of resin configured to cover at least a portion of the crown 23 of the U-shaped body 21. Therefore, the covering body 24 prevents damage to a member to be struck such as an electric wire.

As shown in FIG. 1, compression springs 1f, 1g are provided for biasing the driver 5 in the striking direction. Therefore, the driver 5 can strike the staple 20 by the spring force of the compression springs 1f, 1g.

Various modifications may be made to the embodiments described above. The driving tool was descried as a mechanical spring type. Alternatively, for example, a gas spring type that drives the staples 20 using gas pressure may also be used.

The movable member need not have the shape as described as an example, and may, for example, have a configuration without a slide ramp surface.

The biasing member may be a compression spring alternative to a leaf spring. The rolling element 2r may be spherical other than cylindrical.

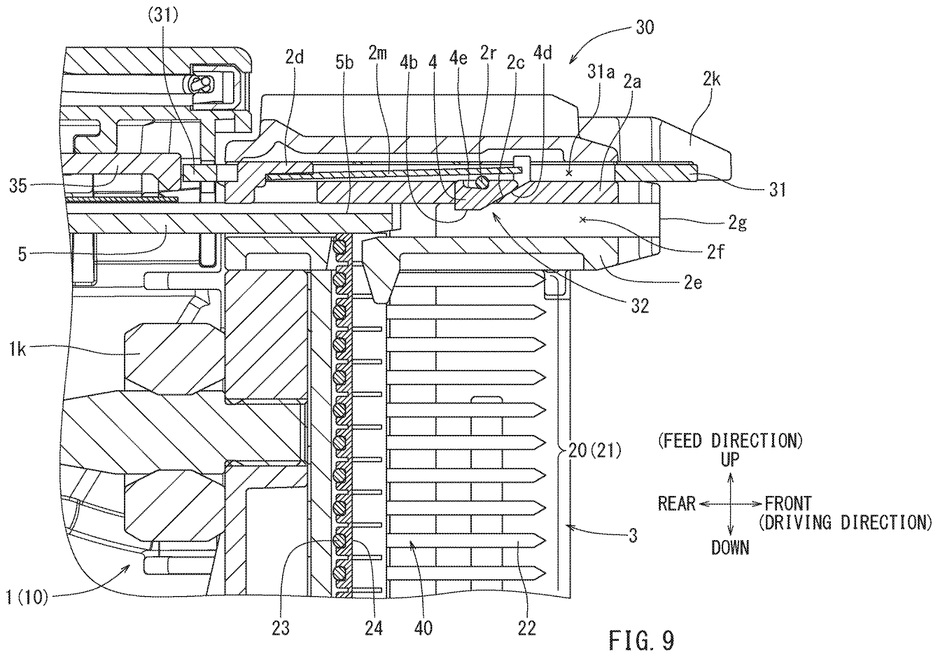

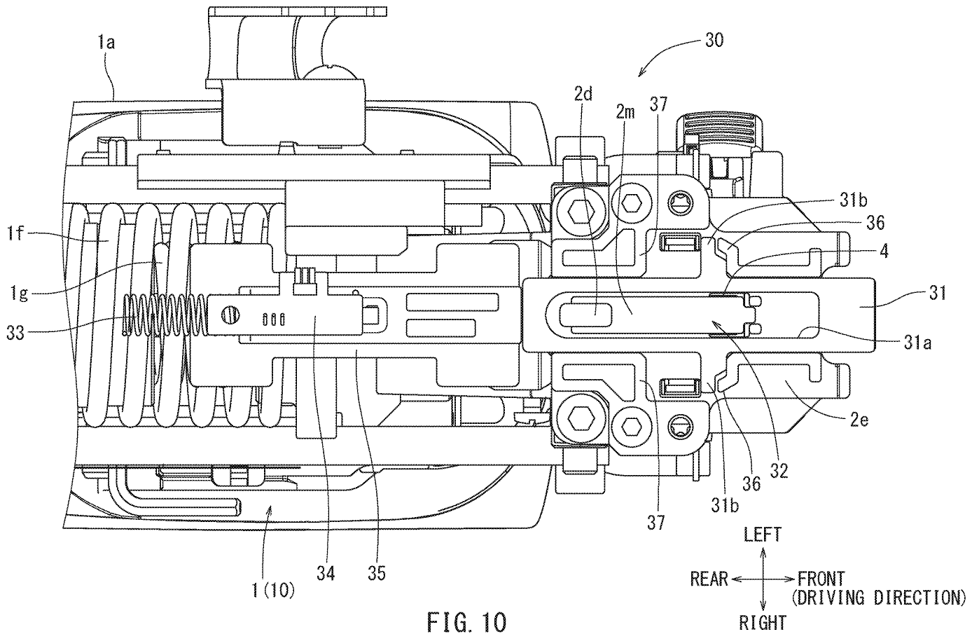

FIGS. 9 and 10 show a driving nose 30 according to a second embodiment. The second embodiment differs from the first embodiment in respect of the contact arm and the relative position of the contact arm and the movable member. Members and configurations that do not require changes are denoted by the same reference numerals, and descriptions thereof are omitted.

In the second embodiment, a mechanism for causing the movable member 4 to interfere with the staple 20 struck by the driver 5 is referred to as an interference mechanism 32. The interference mechanism 32 is constituted by the movable member 4, the leaf spring 2m (biasing member), and the rolling element 2r in the first embodiment.

The contact arm 31 is provided so as to be movable back and forth within a predetermined range along the driving direction. An intermediate plate 35 is adjacent to the rear of the contact arm 31. The intermediate plate 35 is biased forward by a compression spring 33. The contact arm 31 is biased to a forward OFF position by the compression spring 33. The contact arm 31 retreats against the compression spring 33 to reach an ON position. The ON position of the contact arm 31 is detected by a sensor 34 disposed above the intermediate plate 35.

Engaging portions 31b are provided on left and right sides of the contact arm 31. The pair of left and right engaging portions 31b protrude laterally. A pair of left and right front stoppers 36 and a pair of left and right rear stoppers 37 are provided on an upper surface of the lower driver guide 2e. The front stoppers 36 and the rear stoppers 37 are respectively provided on left and right sides of the contact arm 31. The engaging portions 31b of the contact arm 31 are positioned between the front stoppers 36 and the rear stoppers 37. A forward end position of the contact arm 31 is defined by the engaging portions 31b abutting against the front stoppers 36. A rearward end position of the contact arm 31 is defined by the engaging portions 31b abutting against the rear stoppers 37.

The contact arm 31 of the second embodiment is disposed closer to the drive channel 2f than the contact arm 2h of the first embodiment. The contact arm 31 of the second embodiment is provided with a hollow portion 31a. The hollow portion 31a has a substantially rectangular shape and extends long in the front-rear direction. A part of the interference mechanism 32 enters and is disposed in the hollow portion 31a.

In the second embodiment, the leaf spring 2m of the interference mechanism 32 is disposed within the hollow portion 31a. The support portion 2d that supports the rear part of the leaf spring 2m is also disposed within the hollow portion 31a. Moreover, by the driving operation, the movable member 4 and the rolling element 2r are pushed by the staple 20 and displaced upward, thereby entering into the hollow portion 31a.

By allowing a part of an interference mechanism 32 to enter the hollow portion 31a of the contact arm 31 (so as to overlap in a thickness direction of the contact arm 31), the contact arm 31 can be disposed closer to the drive channel 2f. Accordingly, it is possible to make a driving nose 30 more compact in a height direction (so-called reduction of center height).

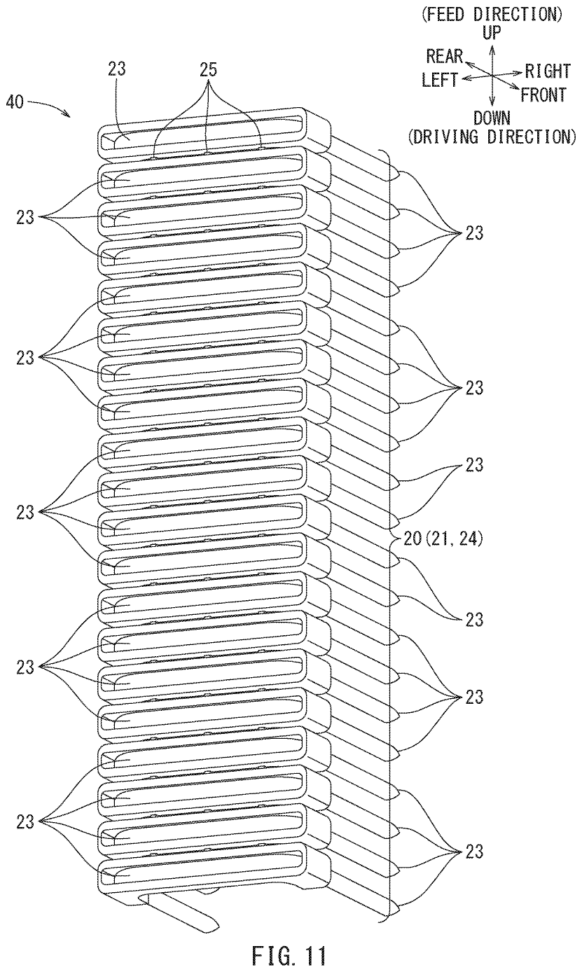

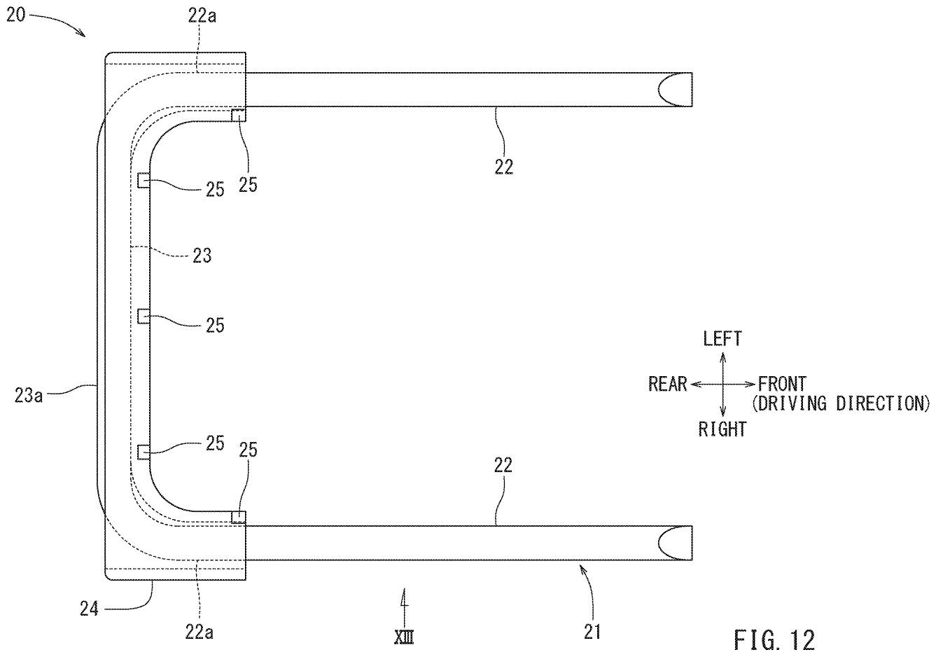

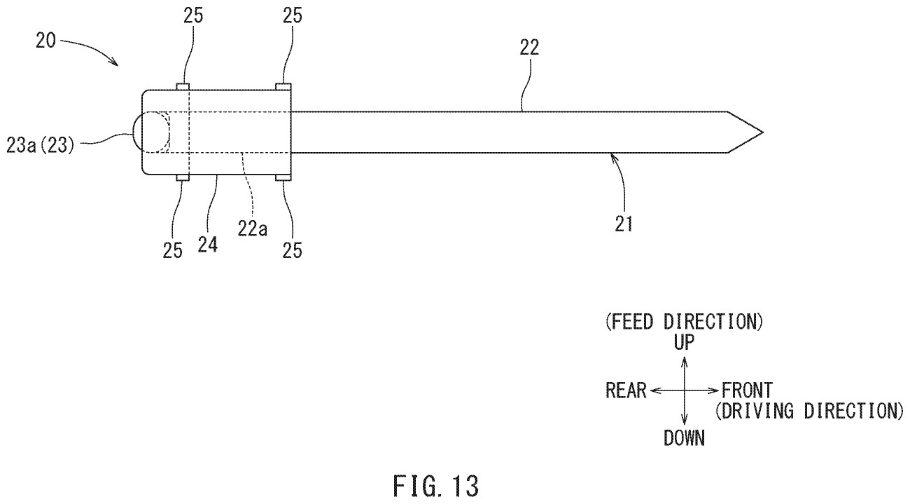

The staple 20 will be further described. FIG. 11 shows a connected staple 40 in which a plurality of staples 20 are connected in parallel. FIGS. 12 and 13 show a single staple 20 as an individual piece. The front-rear, left-right, and up-down directions in the figures are shown aligned with the respective directions of the driving tool 10 when the connected staple 40 is loaded in the magazine 3.

As described above, the staple 20 has a U-shaped body 21 made of metal and covering body 24 made of resin that covers the U-shaped body 21. The U-shaped body 21 has a pair of left and right legs 22 and a crown 23 connecting both legs 22. Base portions 22a of both legs 22 and a part of the crown 23 are covered by the covering body 24.

A rear surface 23a of the crown 23 (a contact surface with the driver 5) is not covered by the covering body 24 and is exposed. The rear surface 23a of the crown 23 slightly protrudes from a rear end of the covering body 24. A front surface (a side from which the legs 22 extend) and the left and right side surfaces of the crown 23 are covered by the covering body 24. A partial region (the base portions 22a) of both legs 22 on the crown 23 side in the longitudinal direction is also covered by the covering body 24.

The covering body 24 made of resin serves as a resin connecting portion that a plurality of staples 20 to each other in the feed direction in the magazine. For example, five connecting portions 25 may be provided on the left and right sides of the covering body 24 of each staple 20. The five connecting portions 25 are disposed at three locations along the longitudinal direction of the crown 23 and at two locations adjacent to the base portions 22a of the left and right legs 22. Two mutually adjacent staples 20 are temporarily coupled to each other via the five connecting portions 25 to constitute one connected staple 40.

The plurality of staples 20 are connected in parallel to each other by the covering body 24 made of resin, and when struck by the driver 5, the connecting portions 25 easily break so that the struck leading staple 20 is easily separated from the second and subsequent connected staples 40. The struck staple 20 is separated with a small force without impairing the striking force of the driver 5.

According to the second embodiment, the driving tool 10 has a contact arm 31 that is movably provided on a driver guide 2a having a drive channel 2f and is brought into contact with an electric wire or the like as a fixing object. The contact arm 31 is disposed to overlap at least a part of an interference mechanism 32 in a thickness direction of the contact arm 31. The interference mechanism 32 is composed of a movable member 4, a biasing member (leaf spring 2m), and a rolling element 2r. Therefore, the interference mechanism 32 is compactly disposed in the thickness direction of the contact arm 31 (a direction intersecting an extending direction of the contact arm 31). This makes it possible to reduce a so-called center height of a driving nose.

According to the second embodiment, the contact arm 31 has a hollow portion 31a in which at least a part of the interference mechanism 32 is inserted. Therefore, the interference mechanism 32 and the contact arm 31 are disposed overlapping in the thickness direction by a simple configuration.

Further modification may be made to the second embodiment. For example, although a configuration was described as an example in which a hollow portion 31a is provided and an interference mechanism 32 is positioned within the hollow portion 31a to overlap the contact arm 31 in a thickness direction, a configuration may be adopted in which the interference mechanism is disposed on left and right sides of the contact arm 31 to overlap the contact arm in the thickness direction. In this case, the hollow portion 31a may be omitted.

In the first and second embodiments, a stapler that drives staples has been exemplified as the driving tool; however, the interference mechanism 32 described above may also be applied to other forms of driving tools, such as a nailer that drives nails. Accordingly, the contact arm is not limited to being brought into contact with an object to be fixed, such as an electric wire, but also includes being brought into contact with a workpiece to be driven, such as a normal plate material.

What is claimed is:

1. A driving tool, comprising:
a drive channel through which staples are supplied;
a movable member that moves between a protruding position protruding into the drive channel and a retracted position retracted from the drive channel in a direction away from a feed-side of the staples; and
a driver configured to strike the staples, wherein the movable member is configured to contact a struck staple so as to correct an orientation of the struck staple, and wherein the movable member is configured to move from the protruding position to the retracted position upon being pushed by the struck staple.

2. The driving tool according to claim 1, further comprising a biasing member configured to bias the movable member toward the protruding position.

3. The driving tool according to claim 2, further comprising a rolling element provided between the biasing member and the movable member.

4. The driving tool according to claim 3, wherein the movable member includes a groove into which the rolling element is inserted.

5. The driving tool according to claim 4, wherein the groove has a shape that deepens toward a striking direction of the driver such that the rolling element projects further from the groove toward the biasing member as the rolling element moves in a direction opposite to the striking direction.

6. The driving tool according to claim 2, wherein the biasing member is a leaf spring.

7. The driving tool according to claim 6, wherein a base portion of the leaf spring in the striking direction of the driver is supported by a tool body, and a front portion of the leaf spring in the striking direction pushes the movable member.

8. The driving tool according to claim 1, further comprising an advance and retract path for the movable member, wherein a front wall of the advance and retract path in the striking direction includes a guide slope extending in a staple feed direction toward the striking direction of the driver.

9. The driving tool according to claim 8, wherein the movable member has a slide ramp surface that engages with the guide slope at a front end in the striking direction and slides along the guide slope.

10. The driving tool according to claim 1, wherein the driver includes a receiving groove that extends in the striking direction and allows the movable member to move relative to the driver without interference.

11. The driving tool according to claim 1, wherein the staples are arranged side by side and connected via a connecting portion with gaps between legs adjacent to each other in a feed direction, and
wherein the staples are fed one by one into the drive channel.

12. The driving tool according to claim 1, wherein the staple has a U-shaped body made of metal and a covering body made of resin configured to cover at least a portion of a crown of the U-shaped body.

13. The driving tool according to claim 1, further comprising a compression spring configured to bias the driver in the striking direction.

14. The driving tool according to claim 3, further comprising a contact arm movably provided on a driver guide having the drive channel and configured to contact a workpiece or a fixing object,
wherein the contact arm is disposed to overlap at least a part of an interference mechanism in a thickness direction of the contact arm, and wherein the interference mechanism includes the movable member, the biasing member, and the rolling element.

15. The driving tool according to claim 14, wherein the contact arm includes a hollow portion in which at least a part of the interference mechanism is inserted.

16. The driving tool according to claim 2, further comprising an adjustment mechanism configured to adjust a magnitude of a biasing force applied by the biasing member to the movable member.

17. The driving tool according to claim 2, wherein a friction-reducing interface is provided between the biasing member and the movable member, the friction-reducing interface comprising at least one of a rolling element, a low-friction coating, or a self-lubricating slide plate.

18. A driving tool, comprising:
a tool body;
a driver guide extending from the tool body and defining a drive channel;
a driver movable within the drive channel in a striking direction to strike a staple;
an interference mechanism configured to contact the staple within the drive channel and retract from the drive channel upon contact; and
a contact arm movably coupled to the driver guide and configured to contact a workpiece, wherein the contact arm overlaps with at least a portion of the interference mechanism in a thickness direction of the contact arm, and wherein the contact arm includes a hollow portion configured to receive at least a portion of the interference mechanism to allow the overlap.

19. The driving tool according to claim 18, wherein the interference mechanism comprises:
a movable member configured to protrude into the drive channel to contact the staple; and
a biasing member configured to bias the movable member toward the drive channel.

20. A driving tool, comprising:
a drive channel;
a movable member movable between a protruding position in the drive channel and a retracted position;
a biasing member configured to bias the movable member toward the protruding position; and
a rolling element disposed between the biasing member and the movable member,
wherein the movable member includes a groove accommodating the rolling element,
wherein the groove has a depth that varies along a striking direction such that the rolling element projects from the groove toward the biasing member by a varying amount depending on a position of the rolling element within the groove, and
wherein, when the movable member moves toward the retracted position, the rolling element moves relative to the groove to a position where the rolling element projects further toward the biasing member to increase a spacing between the movable member and the biasing member.
